(19) United States
(12) Patent Application Publication
(10) Pub. No.: US 2026/0352665 A1
(43) Pub. Date: Nov. 5, 2026

(54) EXPRESSION BASED AUTHORIZATION ENFORCEMENT ON LARGE DATA SET OPERATIONS

(71) Applicant: INTUIT INC., Mountain View, CA (US)

(72) Inventors: Anshul SHARMA, Mountain View, CA (US); Kartikeya CHOUDHARY, San Diego, CA (US); Lillian LOUIE, Fremont, CA (US)

(21) Appl. No.: 19/194,806

(22) Filed: Apr. 30, 2025

(51) Int. Cl. H04L 9/40

(52) U.S. Cl. CPC H04L 63/102; H04L 63/104

(57) ABSTRACT

Aspects of the present disclosure relate to systems and protocols for efficiently authorizing batch data requests. Embodiments include sending a batch query and an authorization request via a computing environment. The batch data may be returned based on the data request. Based on the authorization request, an authorization expression comprising an expression language artifact may be generated and returned to the computing environment. The computing environment may then enforce permissions in the authorization expression by executing the artifact. Executing the artifact may allow a user to access data that the user is authorized to access, while the user may be blocked from accessing unauthorized data.

### INTRODUCTION

Aspects of the present disclosure relate to techniques and systems for implementing data security protocols. In particular, techniques disclosed herein provide for a secure, streamlined authorization process that minimizes the amount of authorization activity required to retrieve and access data.

### BACKGROUND

Every year, millions of people, businesses, and organizations around the world rely on virtual data management systems to securely store and use data. In a typical data management system, data is stored in a database, and users that are authorized to access the data may do so, while unauthorized user may be denied access.

However, in existing data management systems, the authorization process can be cumbersome, resulting in exorbitant latency and computational expense. For example, when performing batch queries on data associated with multiple different profiles, existing techniques may require authorization requests to be sent and approved for each profile in the batch. In large batches with numerous profiles, a proportionally large amount of time and processor resources may be expended to authorize (and/or deny) access to the data within all of the profiles.

Thus, there is a need in the art for improved techniques of authorizing batch data requests.

### BRIEF SUMMARY

Certain embodiments provide a system for performing batch queries. The system generally includes: a remote database; a remote authorization component; one or more processors communicatively coupled to the remote database and the remote authorization component via a network, the one or more processors configured to implement a computing environment and a user interface associated with the computing environment; and a memory comprising instructions that, when executed by the one or more processors, cause the system to: receive, via the user interface associated with the computing environment, a user request indicating a set of data items to be queried from a remote database; transmit, via the computing environment: a query for the set of data items to the remote database, wherein the set of data items comprises data items associated with multiple profiles, wherein the query is generated automatically by the computing environment based on the request, wherein transmitting the query comprises making an application programming interface (API) call to the remote database; and an authorization request for the set of data items to a remote authorization component, wherein the authorization request is generated automatically by the computing environment based on the request, wherein transmitting the authorization request comprises making an API call to the authorization component; receive, at the computing environment, the set of data items based on the query; receive, at the computing environment from the remote authorization component based on the authorization request, an authorization expression comprising an expression language artifact that controls access to each data item of the set of data items; block the user of the computing environment from accessing a first subset of the set of data items via the user interface based on the authorization expression; and allow the user to access a second subset of the set of data items via the user interface based on the authorization expression.

Some embodiments provide a method of performing batch queries. The method generally includes: transmitting, via a computing environment: a query for a set of data items to a data storage environment, wherein the set of data items comprises data items associated with multiple profiles; and an authorization request for the set of data items to an authorization component; receiving, at the computing environment, the set of data items based on the query; receiving, at the computing environment from the authorization component based on the authorization request, an authorization expression that controls access to each data item of the set of data items; blocking a given user of the computing environment from accessing a first subset of the set of data items based on the authorization expression; and allowing the given user to access a second subset of the set of data items based on the authorization expression

Other embodiments provide processing systems configured to perform the aforementioned method as well as those described herein; non-transitory, computer-readable media comprising instructions that, when executed by one or more processors of a processing system, cause the processing system to perform the aforementioned method as well as those described herein; a computer program product embodied on a computer readable storage medium comprising code for performing the aforementioned method as well as those further described herein; and a processing system comprising means for performing the aforementioned method as well as those further described herein.

The following description and the related drawings set forth in detail certain illustrative features of one or more embodiments.

### BRIEF DESCRIPTION OF THE DRAWINGS

The appended figures depict certain aspects of the one or more embodiments and are therefore not to be considered limiting of the scope of this disclosure.

FIG. 1A depicts an example of a batch data authorization process.

FIG. 1B depicts an additional example of a batch data authorization process.

FIG. 2 depicts an example of computing components related to batch data authorization.

FIG. 3 depicts an additional example of computing components related to batch data authorization.

FIG. 4 depicts an example authorization expression.

FIG. 5 depicts example operations related to batch data authorization.

FIG. 6 depicts an example of a processing system for batch data authorization.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

Aspects of the present disclosure provide apparatuses, methods, processing systems, and computer-readable mediums for performing batch data queries using a security authorization protocol.

According to certain embodiments, to accurately and efficiently authorize access to an entire batch of queried data, an authorization request for the batch is sent to an authorization component. Based on the request, the authorization component may generate an authorization expression that controls access to all of the profiles and data within the batch of queried data. The authorization expression may be a single expression language artifact that includes authorization decisions based on identities of the users and classifications of the data. For example, the authorization decisions may specify that, for a first profile within the queried data, the user can only access a first data item if the user identifier associated with the profile matches the identifier of the querying user. Thus, the querying user will only be able to access the first data item if the profile belongs to the querying user. A second data item may be accessible to all users, all users associated with a particular grouping, and/or the like.

In some embodiments, the batch of data and the authorization expression may be returned to the computing environment of the user. Based on the authorization expression, the computing environment may display (or otherwise grant access to, such as read/write access) authorized data from the batch. If the user is not authorized to access the data, the user may be blocked from accessing the data based on the authorization expression.

Embodiments of the present disclosure provide numerous technical and practical effects and benefits. For example, techniques and systems disclosed herein consolidate an authorization protocol for a batch of queried data that includes numerous profiles into a single authorization request and transmission of a single authorization expression. Compared to existing systems that rely on sending one or more authorization requests and authorizations for each profile in a batch of queried data, embodiments of the present disclosure significantly reduce latency and computational overhead while ensuring data security through effective access control. Experimental results demonstrate that the time required to complete and authorize a batch query may be reduced by up to sixty percent using techniques described herein.

### Example of a Batch Data Authorization Process

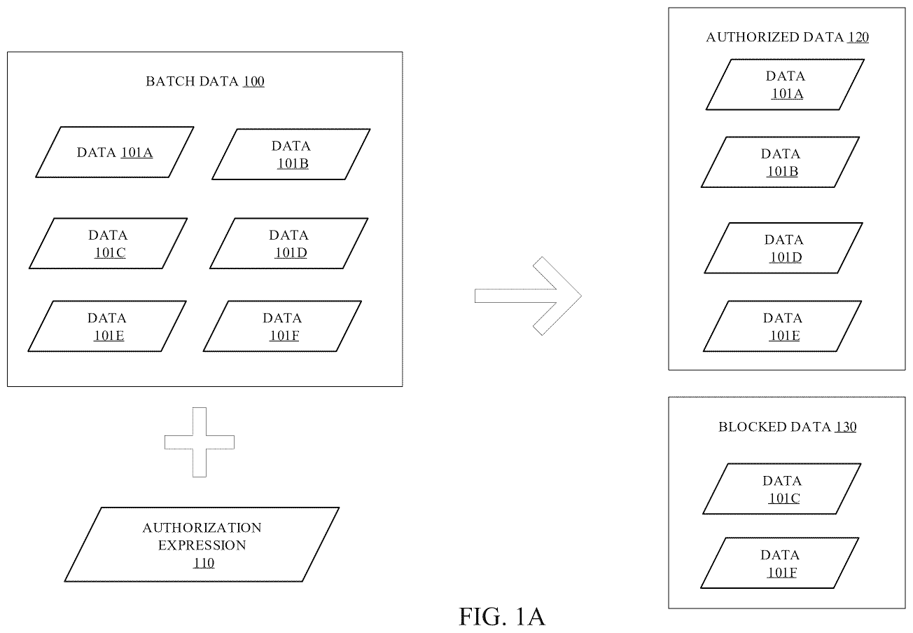

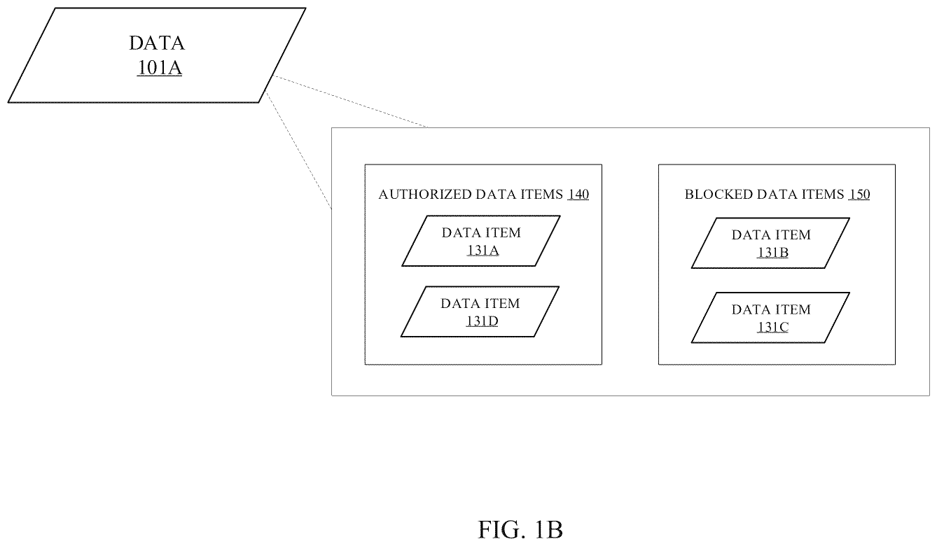

FIG. 1A depicts an example of a batch data authorization process according to certain embodiments.

The batch data 100 may include data 101 from multiple different profiles. The data 101 may generally include any type of data item that can be electronically stored (e.g., in a database). The profiles may be associated with individuals (e.g., a person's user profile on a website), businesses, organizations, and/or other types of entities.

As an example, data 101A and 101B may belong to a first profile, data 101C and 101D may belong to a second profile, data 101E may belong to a third profile, and data item 101F may belong to a fourth profile.

An authorization expression 110 is used to control access to the data items. For example, the authorization expression 110 may control access to profiles of data. The authorization expression 110 may control access to data within each profile. For example, the authorization expression may be an expression language artifact that comprises authorizations decisions for accessing different profiles and/or data items within profiles. When provided with the authorization expression 110 and the batch data 100, a computing environment may grant a user access to authorized data 120 and block the user from accessing blocked data 130. The various authorizations for the user are represented in the authorization expression that is executed by the computing environment.

In the example shown in FIG. 1A, the authorized data 120 includes data 101A, 101B, 101D, and 101E. The blocked data 130 includes data 101C and 101E. Data 101A, 101B, 101D, and 101E may represent data items from profiles that the user is authorized to access. Data 101C and 101E may represent data items from profiles the user is not authorized to access. As shown in FIG. 1B, the authorization expression may further control access to data items within each profile. Data 101A includes various data items 131A-D associated with a given profile. The user is allowed to access the authorized data items 140 (in this example, data items 131A and 131D) and is blocked from accessing the blocked data items (in this example, data items 131B and 131C).

As an example, data item 131A may be a different user's name, and data item 131D may be the different user's profile picture. Data item 131B may be the different user's email address and data item 131C may be the different user's phone number. Thus, based on the authorization expression, the user is able to view the different user's name and profile picture, but not the different user's contact information. Although in some embodiments the user is described as an individual that interacts with a data query system through a user interface, as used herein, the term “user” may also refer to separate computing constructs (e.g., software applications) that utilize the data query system to retrieve data.

### Example Computing Components Related to Batch Data Authorization

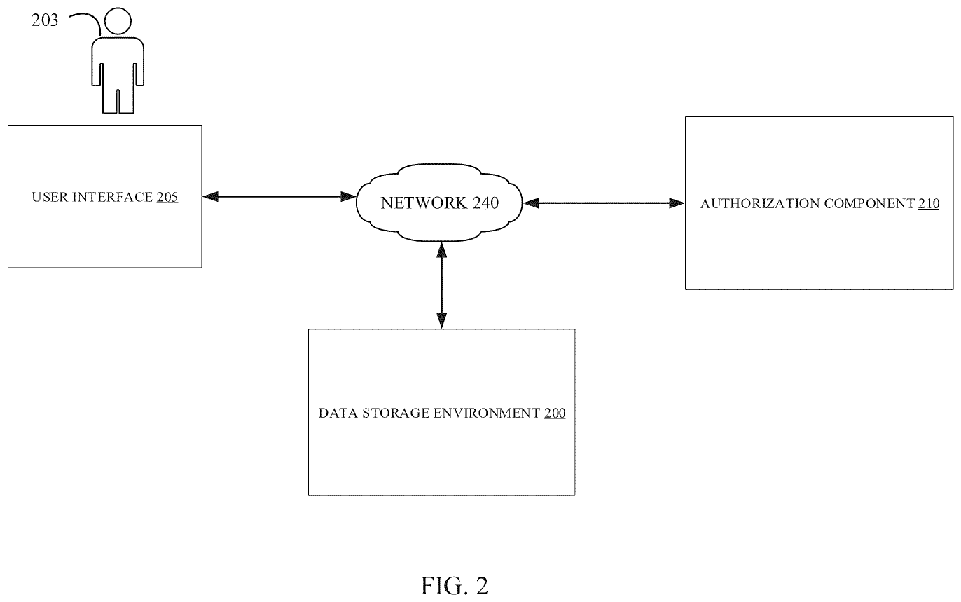

FIG. 2 depicts an example of computing components related to batch data authorization.

A user 203 may interact with a computing environment via a user interface 205 associated with a computing device. The computing environment may, for example, comprise a software application that allows the user 203 to retrieve, access, and/or modify data or perform other tasks involving the data. The computing environment and the user interface may be implemented by one or more components running on one or more processors (e.g., processors remote from a computing device used by the user and/or processors of the computing device)

A data storage environment 200 may be used to store the data that is to be retrieved. The data storage environment 200 may comprise a database, a software application, a cloud storage service, and/or any other system that allows for electronically storing data. The data storage environment 200 may be hosted remotely from the computing environment associated with the user interface (e.g., the data storage environment 200 may be a separate application from an application used by the user 203 to access the data).

An authorization component 210 may comprise one or more computing components (e.g., processors, software applications, and/or the like) that are configured to automatically generate authorization expressions to authorize access to data items based on authorization requests. The authorization component 210 may generate the authorization expressions based on permissions stored in the authorization component 210 and/or received from a computing environment such as data storage environment 200. The authorization component 210 may be hosted remotely from the data storage environment 200 and/or the computing environment associated with the user interface 205. In other embodiments, the authorization component 210 and the data storage environment 200 are implemented as part of the same computing environment (e.g., the authorization component 210 and the data storage environment 200 may be combined into a single software application).

The computing device associated with the user interface 205, the authorization component 210, and the data storage environment 200 may be communicatively coupled using one or more networks 240. For example, data queries may be sent from the computing environment associated with the user interface 205 to the data storage environment 200 via the network 240, and the queried data may be sent from the data storage environment 200 to the computing environment associated with the user interface 205 via the network 240. To authorize the user 203 to access the queried data, an authorization request may be sent from the computing environment associated with the user interface 205 to the authorization component 210 over the network 240. The authorization expression may then be sent from the authorization component 210 to the computing environment associated with the user interface 205 over the network 240. Network(s) 240 may be any connection over which data may be transmitted. Examples of the network(s) 240 may include, without limitation, a wide area network (WAN), a local area network (LAN), and/or a cellular network. In one example, network 240 is the Internet.

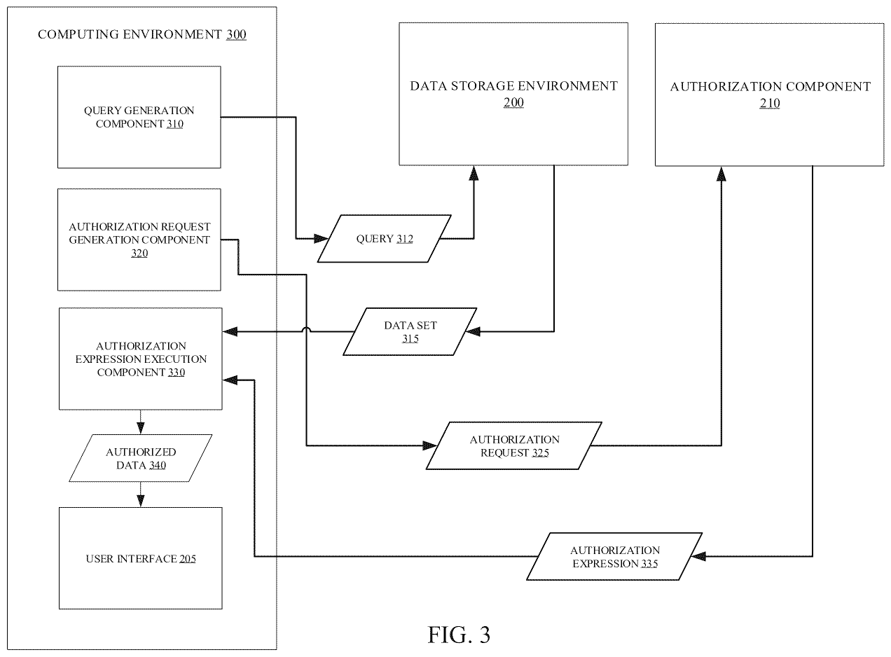

FIG. 3 depicts an additional example of computing components related to batch data authorization.

A computing environment 300 used to retrieve data from a data storage environment 200 may comprise a query generation component 310, an authorization request generation component 320, an authorization expression execution component 330, and a component that implements the user interface 205.

The query generation component 310 may be configured to automatically generate and transmit queries 312 based on user input. The user input may indicate data to be queried. For example, for the user to query data from a set of profiles, the input may specify the set of profiles to be queried. Based on this input, a query 312 for data within the set of profiles may be generated and transmitted by the query generation component 310. For example, the query 312 may be transmitted using an application programming interface (API) call from the query generation component 310 to the data storage environment 200.

Based on the query 312, the data storage environment 200 may transmit a data set 315 to the computing environment 300. The data set 315 may include all of the queried data (e.g., data queried from multiple profiles within the data storage environment 200). The data set 315 may include data items that the user is authorized to access as well as data items that the user is not authorized to access. The data set 315 may be sent to authorization expression execution component 330.

Based on the user input, the authorization request generation component 320 may automatically generate and transmit an authorization request 325 to the authorization component 210. The authorization request 325 may comprise an indication of the data items that are being queried and authorized. For example, if the query 312 is for data items in a set of profiles, the authorization request 325 may indicate the profiles and/or data items. The authorization request 325 may be transmitted by the authorization request generation component 320 to the authorization component 210 via an API call.

Based on the authorization request 325, the authorization component 210 may generate an authorization expression 335 that can be used to control access to the data set 315. The authorization expression 335 may comprise an expression language (e.g., spring expression language, or SPEL) artifact that includes authorization decisions for accessing data items in the data set 315. The authorization expression 335 may be automatically generated based on permissions stored in the authorization component 210 (or sent to the authorization component from another computing environment such as the data storage environment 200 based on the query 312) for each profile and/or data item indicated in the query 312. For example, the authorization expression 335 may specify levels of permission for different users based on user identifiers and classifications of data.

In an example, different data items within a profile may have different classifications (e.g., public, restricted, sensitive, highly sensitive, secret, and/or the like). A first data item within a profile may be classified as public (e.g., any user may access the data item). A second data item within the profile may be classified as restricted (e.g., only a specified set of users may access the data item). A third data item within the profile may be classified as sensitive. A fourth data item within the profile may be classified as highly sensitive. A fifth data item within the profile may be classified as secret. Depending on the classification, the data item may be completely inaccessible by the user (e.g., secret data items may only be accessed by the owner of the profile). Other data items may be fully accessible (e.g., public items) or partially accessible (e.g., sensitive items). For example, a partially accessible data item may have certain restricted parts redacted.

As mentioned above, certain data items such as public data items may be accessed by any user. Other data items may only be accessed by a certain users, certain groups of users, and/or the like. For example, some data items may only be accessed by the user if an identifier associated with the user matches the identifier of the owner of the profile that contains the data item (in other words, the user owns the data item). Other items may only be accessed by identifiers specified in the permissions or groups of users specified in the permissions. For example, a group of specific users may be able to access a data item, or every user that falls under a certain group (e.g., administrator) may be able to access the data item.

The expression language artifact may represent the authorization decisions in a format that allows the authorization expression execution component 330 to execute the decisions and allow the user to access data items that the user is authorized to access (e.g., authorized data 340) and block the user from accessing other data in the data set 315. For example, authorization expression execution component 330 may execute authorization expression 335 with respect to data set 315 by parsing authorization expression 335 according to the expression language in which authorization expression 335 is constructed to identify permissions, and evaluating the decisions within authorization expression 335 to determine whether to block or grant access to particular data items within data set 315 for one or more particular users.

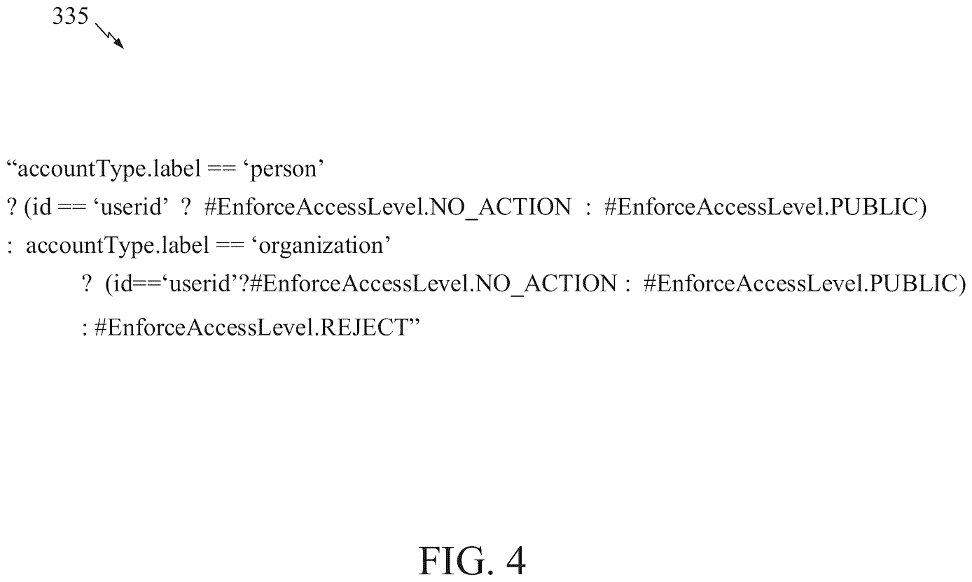

FIG. 4 represents an example authorization expression 335.

The example authorization expression 335 shown in FIG. 4 represents authorization decisions for a set of data items (e.g., data items associated with a profile) requested in a query. In the example authorization expression 335, if the type grouping for the user account that is querying the data item is “person,” then the user will be given full access to the data items if the identifier for the user matches the user identifier for the user that owns the data items (e.g., the user that owns the profile). If the type grouping for the user account that is querying the data items is “person” and the identifier for the user does not match the user identifier for the user that owns the data items, then “public” enforcement may be enacted. In other words, the user performing the query will only be able to access data items within the set of data items that are classified as “public.”

If the type grouping for the user account that is querying the data items is “organization,” then the user will be given full access to the data items if the identifier for the user matches the user identifier for the user that owns the data items. If the type grouping for the user account that is querying the data item is “organization” and the identifier for the user does not match the user identifier for the user that owns the data items, then “public” enforcement may be enacted. In other words, the user performing the query will only be able to access data items within the set of data items that are classified as “public.” If the type grouping for the user account that is querying the data items is neither “person” nor “organization,” then the user will be rejected, meaning that the user will not be able to access any of the data items. Although not shown, in another example, a third grouping of users (e.g., administrators, or another group besides person or organization) may be given restricted access, meaning that the third grouping has access to restricted data. In other example, a group of user identifiers may be specified as having highly sensitive access, meaning that the group of users associated with the specified identifiers are also able to access highly sensitive data.

Returning to FIG. 3, once the authorization component 210 generates the authorization expression 335, the authorization expression 335 may be transmitted to the authorization expression execution component 330. The authorization expression execution component 330 may execute the expression language artifact to allow the user to access authorized data 340. For example, the authorized data 340 may be displayed via the user interface 205, presented to allow the user to perform actions (e.g., read/write) with the authorized data 340, and/or the like. Other data in the data set 315 besides the authorized data 340 may not be accessible by the user (e.g., the other data may not be sent to the user interface 205 or otherwise presented to the user).

In some embodiments, the data in the data set 315 may be protected by encryption protocols, cryptographic protocols, and/or otherwise secured against unauthorized access by techniques as known in the art. Only when the data is authorized may the data be unencrypted or otherwise unsecured such that the user can access the data. For example, the authorization expression execution component 330 may execute the expression language artifact by decrypting encrypted data items according to the authorization expression 335.

Although authorization component 210 is depicted as a separate component from data storage environment 200, in some embodiments, the authorization component 210 may be implemented as part of storage environment 200 (e.g., as part of the same software application). In such embodiments, the query 312 and the authorization request 325 may be consolidated into the same API call. In other words, requesting the data from the data storage environment 200 may also function to request authorization of the data when the authorization component 210 and the data storage environment 200 are implemented as the same component. In some embodiments, authorization expression execution component 330 may be implemented as part of data storage environment 200 (instead of computing environment 300). Thus, the authorization expression 335 may be executed at data storage environment 200, and only the authorized data 340 may be sent to the computing environment 300. Such embodiments may involve transmitting the authorization expression 335 to the data storage environment 200.

### Example Operations Related to Batch Data Authorization

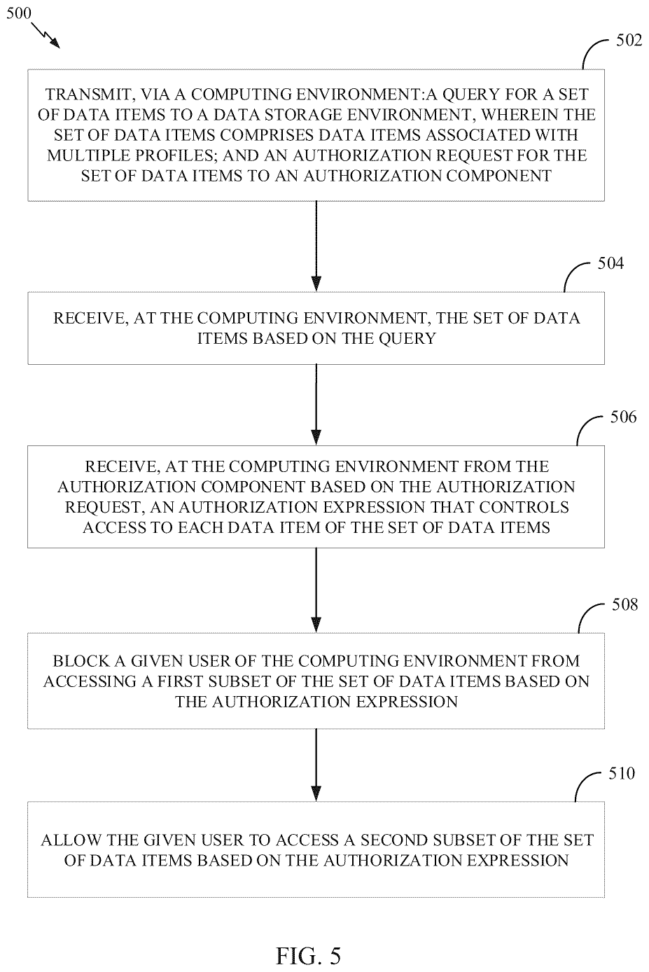

FIG. 5 depicts example operations 500 related to batch data authorization. For example, operations 500 may be performed by one or more of the components described with respect to FIG. 2 and FIG. 3.

Operations 500 begin at step 502 with transmitting, via a computing environment: a query for a set of data items to a data storage environment, wherein the set of data items comprises data items associated with multiple profiles; and an authorization request for the set of data items to an authorization component. According to some embodiments, the authorization request consists of a single application programming interface (API) call made by the computing environment to the authorization component. In certain embodiments, the computing environment generates and transmits the query and the authorization request automatically based on the user indicating the set of data items via a user interface associated with the computing environment. According to some embodiments, the data storage environment comprises a remote database.

Operations 500 continue at step 504 with receiving, at the computing environment, the set of data items based on the query.

Operations 500 continue at step 506 with receiving, at the computing environment from the authorization component based on the authorization request, an authorization expression that controls access to each data item of the set of data items. In some embodiments, the authorization expression comprises an expression language artifact that specifies authorization decisions for each data item of the set of data items that are based on identifiers associated with users. According to some embodiments, the authorization decisions further comprise levels of permission for different classifications for each data item of the set of data items. Certain embodiments provide that, based on the classifications, a given group of users is able to access a given data item of the set of data items based on identifiers associated with the given group of users. In some embodiments, based on the classifications, a particular group of users is blocked from accessing the given data item of the set of data items based on identifiers associated with the particular group of users.

Operations 500 continue at step 508 with blocking a given user of the computing environment from accessing a first subset of the set of data items based on the authorization expression.

Operations continue at step 510 with allowing the given user to access a second subset of the set of data items based on the authorization expression.

According to some embodiments, the second subset consists of all data items associated with a given profile; based on a first user being associated with a first grouping, the first user is granted access to each data item of the second subset; based on a second user being associated with a second grouping, the second user is blocked from accessing every data item of the second subset; and based on a third user being associated with a third grouping, the third user is granted access to one or more given data items of the second subset and blocked from accessing one or more particular data items of the second subset.

### Example of a Processing System for Batch Data Authorization

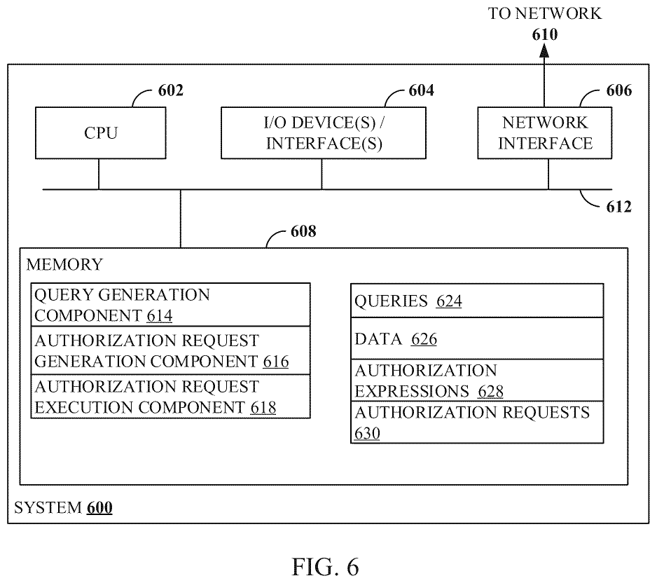

FIG. 6 illustrates an example system 600 with which embodiments of the present disclosure may be implemented. For example, system 600 may be configured to perform operations 500 of FIG. 5 and/or to implement one or more components as in FIG. 2, and FIG. 3.

System 600 includes a central processing unit (CPU) 602, one or more I/O device interfaces that may allow for the connection of various I/O devices 604 (e.g., keyboards, displays, mouse devices, pen input, etc.) to the system 600, network interface 606, a memory 608, and an interconnect 612. It is contemplated that one or more components of system 600 may be located remotely and accessed via a network 610. It is further contemplated that one or more components of system 600 may comprise physical components or virtualized components.

CPU 602 may retrieve and execute programming instructions stored in the memory 608. Similarly, the CPU 602 may retrieve and store application data residing in the memory 608. The interconnect 612 transmits programming instructions and application data, among the CPU 602, I/O device interface 604, network interface 606, and memory 608. CPU 602 is included to be representative of a single CPU, multiple CPUs, a single CPU having multiple processing cores, and other arrangements.

Additionally, the memory 608 is included to be representative of a random access memory or the like. In some embodiments, memory 608 may comprise a disk drive, solid state drive, or a collection of storage devices distributed across multiple storage systems. Although shown as a single unit, the memory 608 may be a combination of fixed and/or removable storage devices, such as fixed disc drives, removable memory cards or optical storage, network attached storage (NAS), or a storage area-network (SAN).

As shown, memory 608 includes query generation component 614, authorization request generation component 616, and authorization request execution component 618. Query generation component 614 may be representative of query generation component 310 of FIG. 3. In some embodiments, authorization request generation component 616 may be representative of authorization request generation component 320 of FIG. 3. Authorization request execution component 618 may be representative of authorization expression execution component 330 of FIG. 3.

Memory 608 further comprises queries 624, which may correspond to query 312 of FIG. 3. Memory 608 further comprises data 626 which may correspond to data set 315 or authorized data 340 of FIG. 3 as well as batch data 100, authorized data 120 and blocked data 130 of FIG. 1. Memory 608 further comprises authorization expressions 628 which may correspond to authorization expression 110 of FIG. 1 as well as authorization expression 335 of FIG. 3. Memory 608 further comprises authorization requests 630 which may correspond to authorization request 325 of FIG. 3.

It is noted that in some embodiments, system 600 may interact with one or more external components, such as via network 610, in order to retrieve data and/or perform operations.

### Additional Considerations

The preceding description provides examples, and is not limiting of the scope, applicability, or embodiments set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The preceding description is provided to enable any person skilled in the art to practice the various embodiments described herein. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and other operations. Also, “determining” may include receiving (e.g., receiving information), accessing (e.g., accessing data in a memory) and other operations. Also, “determining” may include resolving, selecting, choosing, establishing and other operations.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

A processing system may be implemented with a bus architecture. The bus may include any number of interconnecting buses and bridges depending on the specific application of the processing system and the overall design constraints. The bus may link together various circuits including a processor, machine-readable media, and input/output devices, among others. A user interface (e.g., keypad, display, mouse, joystick, etc.) may also be connected to the bus. The bus may also link various other circuits such as timing sources, peripherals, voltage regulators, power management circuits, and other types of circuits, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer-readable medium. Software shall be construed broadly to mean instructions, data, or any combination thereof, whether referred to as software, firmware, middleware, microcode, hardware description language, or otherwise. Computer-readable media include both computer storage media and communication media, such as any medium that facilitates transfer of a computer program from one place to another. The processor may be responsible for managing the bus and general processing, including the execution of software modules stored on the computer-readable storage media. A computer-readable storage medium may be coupled to a processor such that the processor can read information from, and write information to, the storage medium. In the alternative, the storage medium may be integral to the processor. By way of example, the computer-readable media may include a transmission line, a carrier wave modulated by data, and/or a computer readable storage medium with instructions stored thereon separate from the wireless node, all of which may be accessed by the processor through the bus interface. Alternatively, or in addition, the computer-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module, it will be understood that such functionality is implemented by the processor when executing instructions from that software module.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

1. A system, comprising:
a remote database;
a remote authorization component;
one or more processors communicatively coupled to the remote database and the remote authorization component via a network, the one or more processors configured to implement a computing environment and a user interface associated with the computing environment; and
a memory comprising instructions that, when executed by the one or more processors, cause the system to:
receive, via the user interface associated with the computing environment, a request indicating a set of data items to be queried from the remote database;
transmit, via the computing environment:
a query for the set of data items to the remote database, wherein the set of data items comprises a first subset of encrypted data items that a given user is not allowed to access and a second subset of encrypted data items that the given user is allowed to access, wherein the query is generated automatically by the computing environment based on the request, wherein transmitting the query comprises making an application programming interface (API) call to the remote database; and
an authorization request for the set of data items to the remote authorization component, wherein the authorization request is generated automatically by the computing environment based on the request, wherein transmitting the authorization request comprises making an API call to the remote authorization component;
receive, at the computing environment, the set of data items based on the query;
receive, at the computing environment, an authorization expression that is automatically generated by the remote authorization component based on the authorization request and comprises an expression language artifact that controls access to each data item of the set of data items;
determine not to decrypt the first subset of data items based on the authorization expression;
decrypt the second subset of data items based on the authorization expression; and
allow the given user to access the second subset of data items via the user interface.

2. The system of claim 1, wherein:
the second subset consists of all data items associated with a given profile;
based on a first user being associated with a first grouping, the first user is granted access to each data item of the second subset;
based on a second user being associated with a second grouping, the second user is blocked from accessing every data item of the second subset; and
based on a third user being associated with a third grouping, the third user is granted access to one or more given data items of the second subset and blocked from accessing one or more particular data items of the second subset.

3. A system, comprising:
one or more processors; and
a memory comprising instructions that, when executed by the one or more processors, cause the system to:
transmit, via a computing environment:
a query for a set of data items to a data storage environment, wherein the set of data items comprises a first subset of encrypted data items that a given user is not allowed to access and a second subset of encrypted data items that the given user is allowed to access; and
an authorization request for the set of data items to an authorization component;
receive, at the computing environment, the set of data items based on the query;
receive, at the computing environment, an authorization expression that is automatically generated by the authorization component based on the authorization request and comprises an expression language artifact that controls access to each data item of the set of data items;
determine not to decrypt the first subset of data items based on the authorization expression; and
decrypt the second subset of data items based on the authorization expression.

4. The system of claim 3, wherein the authorization expression specifies authorization decisions for each data item of the set of data items that are based on identifiers associated with users.

5. The system of claim 4, wherein the authorization decisions further comprise levels of permission for different classifications for each data item of the set of data items.

6. The system of claim 5, wherein, based on the classifications, a given group of users is able to access a given data item of the set of data items based on identifiers associated with the given group of users.

7. The system of claim 5, wherein, based on the classifications, a particular group of users is blocked from accessing a given data item of the set of data items based on identifiers associated with the particular group of users.

8. The system of claim 3, wherein:
the second subset consists of all data items associated with a given profile;
based on a first user being associated with a first grouping, the first user is granted access to each data item of the second subset;
based on a second user being associated with a second grouping, the second user is blocked from accessing every data item of the second subset; and
based on a third user being associated with a third grouping, the third user is granted access to one or more given data items of the second subset and blocked from accessing one or more particular data items of the second subset.

9. The system of claim 3, wherein the authorization request consists of a single application programming interface (API) call made by the computing environment to the authorization component.

10. The system of claim 3, wherein the computing environment generates and transmits the query and the authorization request automatically based on the given user indicating the set of data items via a user interface associated with the computing environment.

11. The system of claim 3, wherein the data storage environment is remote with respect to the computing environment and the authorization component is remote with respect to the computing environment and the data storage environment.

12. A method, comprising:
transmitting, via a computing environment:
a query for a set of data items to a data storage environment, wherein the set of data items comprises a first subset of encrypted data items that a given user is not allowed to access and a second subset of encrypted data items that the given user is allowed to access; and
an authorization request for the set of data items to an authorization component;
receiving, at the computing environment, the set of data items based on the query;
receiving, at the computing environment, an authorization expression that is automatically generated by the authorization component based on the authorization request and comprises an expression language artifact that controls access to each data item of the set of data items;
determining not to decrypt the first subset of data items based on the authorization expression; and
decrypting the second subset of data items based on the authorization expression.

13. The method of claim 12, wherein the authorization expression specifies authorization decisions for each data item of the set of data items that are based on identifiers associated with users.

14. The method of claim 13, wherein the authorization decisions further comprise levels of permission for different classifications for each data item of the set of data items.

15. The method of claim 14, wherein, based on the classifications, a given group of users is able to access a given data item of the set of data items based on identifiers associated with the given group of users.

16. The method of claim 14, wherein, based on the classifications, a particular group of users is blocked from accessing a given data item of the set of data items based on identifiers associated with the particular group of users.

17. The method of claim 12, wherein:
the second subset consists of all data items associated with a given profile;
based on a first user being associated with a first grouping, the first user is granted access to each data item of the second subset;
based on a second user being associated with a second grouping, the second user is blocked from accessing every data item of the second subset; and
based on a third user being associated with a third grouping, the third user is granted access to one or more given data items of the second subset and blocked from accessing one or more particular data items of the second subset.

18. The method of claim 12, wherein the authorization request consists of a single application programming interface (API) call made by the computing environment to the authorization component.

19. The method of claim 12, wherein the computing environment generates and transmits the query and the authorization request automatically based on the given user indicating the set of data items via a user interface associated with the computing environment.

20. The method of claim 12, wherein the data storage environment is remote with respect to the computing environment and the authorization component is remote with respect to the computing environment and the data storage environment.
